(19) United States
(12) Patent Application Publication
(10) Pub. No.: US 2003/0186596 A1
(43) Pub. Date: Oct. 2, 2003

(54) Electrical terminal for surge protection cartridge

(75) Inventors: Thomas Baum, Naperville, IL (US); Albert McGovern, Naperville, IL (US); Daniel Hoeft, Niles, IL (US); Jane Lee, Bloomingdale, IL (US)

Correspondence Address: JONES DAY, 77 WEST WACKER, CHICAGO, IL, 60601-1692, US

(73) Assignee: Marconi Communications, Inc., Cleveland, OH

(21) Appl. No.: 10/114,138

(22) Filed: Apr. 2, 2002

(51) Int. Cl. H01R 11/22

(52) U.S. Cl. 439/857

(57) ABSTRACT

An electrical terminal and a system of the terminal and a housing is disclosed as an example of the present invention. The electrical terminal and the housing have a number of advantages including being sufficiently stiff to prevent arcing and physical damage to the electrical terminal upon being exposed to surge current/voltage. The terminal includes a contact with a base portion from which two spaced apart arms extend outwardly. First portions of the arms are generally parallel to one another. Second portions of the arms converge toward each other and then flare outwardly along third portions of the arms. At the junction of the second and third portions, there is a contact region formed to receive the lead of a surge protection device. The tenminal is enclosed in an opening in the electrically insulative housing, the opening being bordered by walls closely adjacent to the first portions of the arms. The spacing of the walls from the arms is about 0.001 inches on each side of the terminal. When the tenminal is exposed to a surge current/voltage, the walls stiffen the tenminal and prevent arcing and physical damage.

### BACKGROUND OF THE INVENTION

1. Field Of The Invention

The present invention relates to an electrical terminal and more particularly to an electrical terminal and housing for use with a surge protection cartridge which is simple, reliable and economical.

2. Description Of The Related Art

Surge protection cartridges or modules may be used with modular terminal block assemblies in telecommunication networks as shown and described, for example, in U.S. Pat. Nos. 5,627,721; 5,779,504 and 6,243,250. The surge protection cartridge includes over-voltage/over-current protection devices to protect telecommunication networks from malfunctions and the users of the networks from injury, due to high voltage/high current surges. An important principal of electrical protection is to provide a low impedance path to ground for undesirable or foreign voltages, such as those created by lightning. On a telephone line circuit, current flows into the telephone equipment on the tip lead and returns on the ring lead. Voltage is applied to the telephone line so that the current will flow through the telephone equipment. When the voltage on the line at the protection device raises above a preset level, usually 200-600 volts, a change of state in the protection device occurs and the current flows to ground while the undesirable high voltage is maintained. When high current flows through the contact interface of the protection device and the tip terminal, an electromagnetic force, which is referred to as “repulsion force” or “blow-off”, may create a gap at the contact interface. Consequently, electrical arcing may occur and erode the contact surface, and/or weld surfaces together or create a high resistance, or result in an open circuit causing a network malfunction.

An existing tip clip design that has not proven effective is shown in FIGS. 1 and 2. The design is of a tip terminal or clip 10 having a first electrical contact 12, a second electrical contact 14 and a bridge 16. At each end of the tip clip is a connector barb, a right barb 18 and a left barb 20.

The second electrical contact 14 includes a base portion 22, two converging arm portions 24, 26, a contact region 28 and flare portions 29, 30. The width of each arm portion, from a left surface 31 to a right surface 32, is 0.080 inches and the distance from a bottom surface 34 of the base 22 to the contact region is 0.227 inches. The length of the two arms from the base is 0.314 inches. The distance across from arm to arm at its greatest extent is 0.180 inches. The thickness of each arm is 0.020 inches and the material of the clip is Olin Brass C510 phosphor bronze. The clip is plated with electro tin (150-200 micro inches) over nickel (50-100 micro inches) which in turn is plated over copper flash (30-50 micro inches). As seen in FIG. 2, the width of the rounded opening of the contact region is 0.030 inches and the gap between the arms at the contact region is 0.004 inches. The spring constant of the tip clip is 0.073 lb./mil. The diameter of a protection device lead is 0.039 plus or minus 0.001 inches. When such a lead is inserted into the clip, the deformation of the clip is between 0.003-0.006 inches. At these deformations, the contact normal force is 0.45-0.9 pounds.

When the tip clip shown in FIGS. 1 and 2 was tested by exposure to a 10 kA current surge test, there was arcing and physical damage in the contact region.

### BRIEF SUMMARY OF THE INVENTION

The difficulties encountered with the previous tip clip have been overcome by the present invention. What is described here is an electrical terminal for a surge protection cartridge used with a standard telecommunication frame, said terminal for receiving a lead of an existing surge protection device and comprising a metal element having a first contact portion, a second contact portion and a spanning portion connecting the first and the second contact portions, the second contact portion including a base and first and second arms extending away from the base, the arms being generally parallel to one another along first portions of the arms, the arms converging toward one another along second portions of the arms, and the arms being flared away from one another along third portions of the arms.

There are a number of advantages, features and objects achieved with the current invention which are believed not to be available in earlier related devices. For example, one advantage is that the present invention provides an electrical terminal or tip clip which is simple, effective and economical. Another object of the present invention is to provide a tip clip with increased normal force at the region of contact with a lead to enhance that contact. Another object of the present invention is to provide a tip clip which does not exhibit arcing and physical damage when exposed to a 10 kA current surge test; the surge does not destroy the electrical contact and the terminal continues to function after the surge event.

A more complete understanding of the present invention, and other objects advantages and features thereof will be gained from a consideration of the following description of the preferred embodiment read in conjunction with the accompanying drawing provided herein. The preferred embodiment represents an example of the invention which is described here in compliance with Title 35 U.S.C. § 112 (1^{st} paragraph).

### BRIEF DESCRIPTION OF THE SEVERAL VIEWS OF THE DRAWING

FIG. 1 is an isometric view of a prior art electrical terminal.

FIG. 2 is an enlarged sectional plan view taken along line 2-2 of FIG. 1.

FIG. 3 is a partial exploded isometric view of a surge protection cartridge without protection devices.

FIG. 4 is a partial exploded isometric view of the surge protection cartridge illustrating the placement of protection devices.

FIG. 5 is a downward-looking isometric view of an electrically insulative housing of the surge protection cartridge.

FIG. 6 is an upward-looking isometric view of the housing of FIG. 5.

FIG. 7 is a bottom plan view of the housing of FIGS. 5 and 6.

FIG. 8 is an enlarged bottom plan view of a portion of the housing taken within the circle 8-8 of FIG. 7.

FIG. 9 is a sectional elevation view of the housing taken along line 9-9 of FIG. 8.

FIG. 10 is an isometric view of an example of the electrical terminal of the present invention.

FIG. 11 is an enlarged front elevation view of a portion of the electrical terminal shown in FIG. 10.

FIG. 12 is an enlarged sectional plan view taken along line 12-12 of FIG. 11.

FIG. 13 is an enlarged view of a portion of the housing shown in FIG. 9 with a mounted electrical terminal.

### DETAILED DESCRIPTION OF A PREFERRED EMBODIMENT OF THE INVENTION

While the present invention is open to various modifications and alternative constructions, the preferred embodiment shown in the drawing will be described herein in detail. It is understood, however, that there is no intention to limit the invention to the particular form or example disclosed. On the contrary, the intention is to cover all modifications, equivalent structures and methods, and alternative constructions falling within the spirit and scope of the invention as expressed in the appended claims, pursuant to Title 35 U.S.C. § 112 (2^{nd} paragraph).

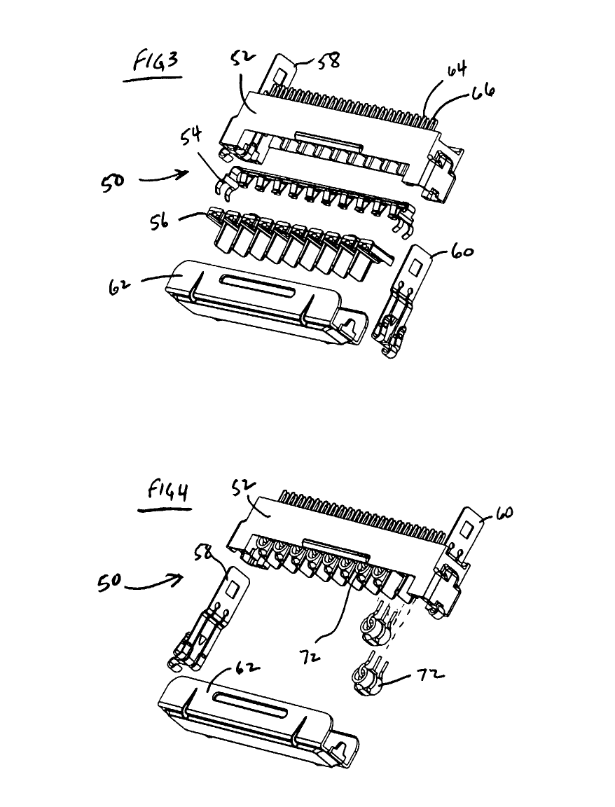

Referring now to the drawing, an example of the invention as illustrated. In FIG. 3, a surge protection cartridge 50 (but without the protection devices) is illustrated and includes an electrically insulative ten-pair housing 52, a grounding element 54, a guide strip 56, two attachment clips 58, 60, a cover 62 and tip and ring terminals such as the tip terminal or clip 64 and the ring terminal or clip 66. In FIG. 4, the surge protection cartridge is partially assembled and includes surge protection devices such as the devices 70, 72. After the surge protection devices are inserted into the cartridge and the cover attached, a compact, robust module is the result.

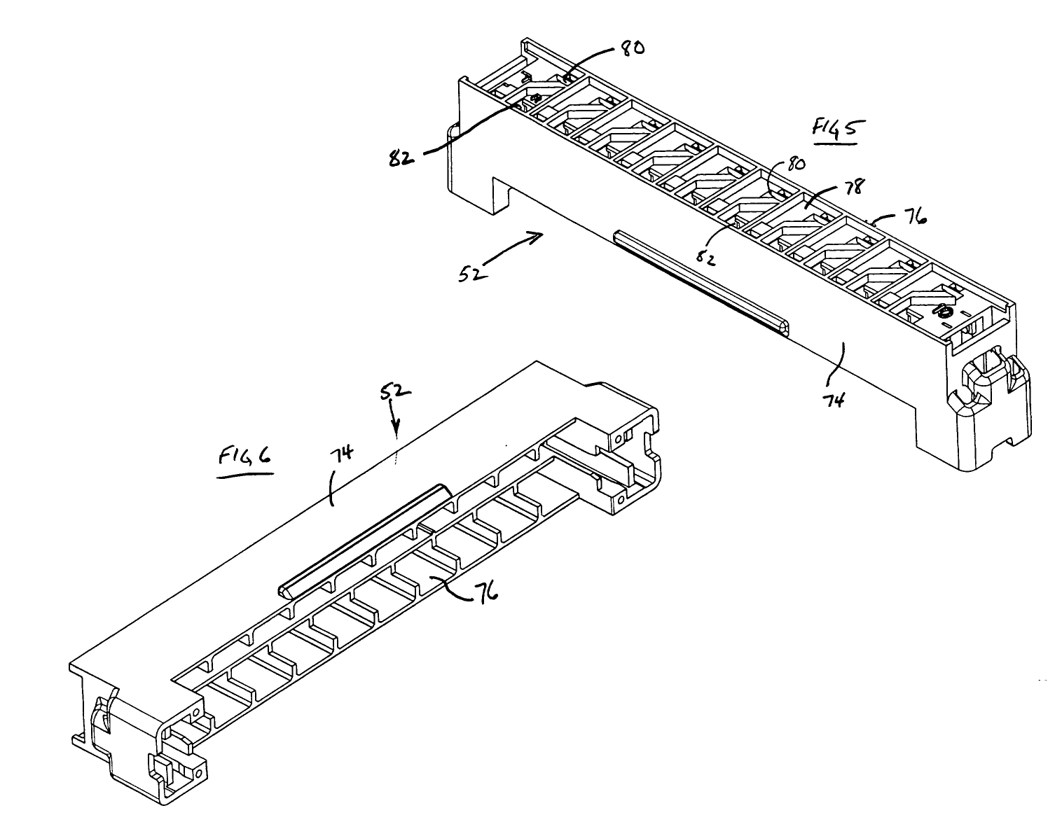

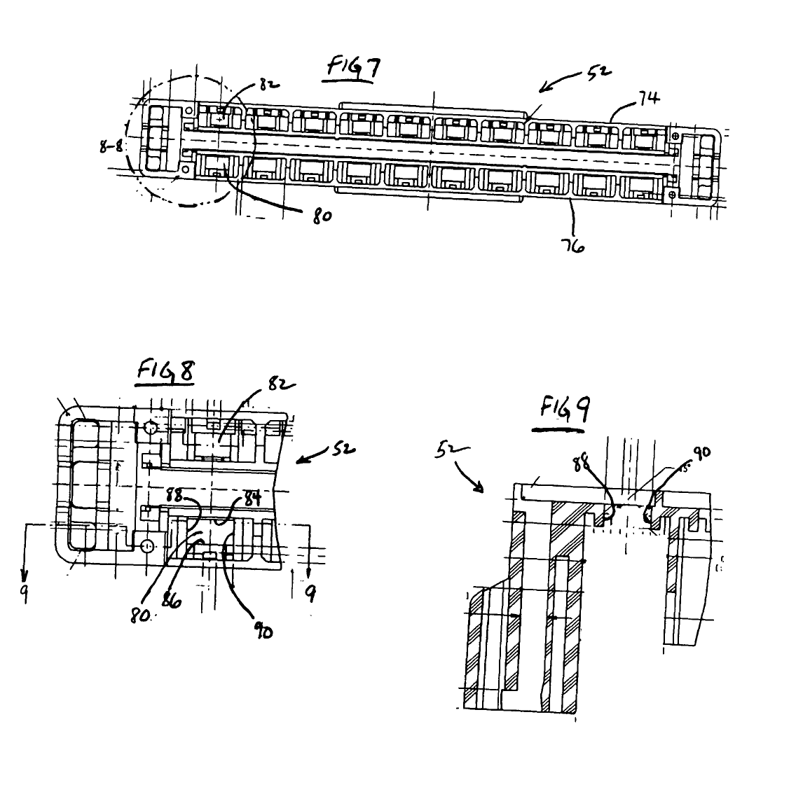

Referring now to FIGS. 5 and 6, two views of the housing 52 are illustrated. The housing includes sidewalls 74, 76 and a top wall 78 partitioned into ten regions. Each region includes an opening to receive a tip clip such as the opening 80 and a corresponding opening to receive a ring clip such as the opening 82. Referring to FIGS. 7-9, the tip clip opening is rectangular in shape with longitudinal walls 84, 86 and lateral walls 88, 90. As will be explained below, the lateral walls 88, 90 fit closely to the tip clip after installation. The lateral walls provide support to the tip clip should a “blow-off” force be experienced. After mounting the tip clip to the housing and receipt of a lead from an installed surge protection device, the tip clip has approximately 0.001 inches of clearance on either side from the lateral walls, spaces which are labelled 92, 94 in FIG. 13.

Referring now to FIGS. 10-13, an electrical terminal in the form of a tip clip 100 is illustrated. The tip clip includes a first electrical contact 102, a second electrical contact 104 and a spanning portion 106. A first connecting barb 108 is located near the first contact 102 and a second connecting barb 110 is located near the second electrical contact 104.

The second electrical contact 104 includes a base portion 112 connected to opposing arms 114, 116 where the arms have first portions 118, 120 which are generally parallel to each other, second portions 122, 124 which are formed to converge toward one another and third flared or diverging portions 126, 128. A contact region 130 is formed between the arms 114, 116 at approximately the junction of the second and third portions. The contact region has generally curved walls 127, 129 on each arm so as to receive a cylindrically shaped lead from a surge protection device. The first portions 118, 120 of the two arms include outer surfaces 132, 134, respectively. These outer surfaces may, under circumstances of a blow-off force caused by lightning, abut the lateral walls of the housing so as to support and stiffen the tip clip.

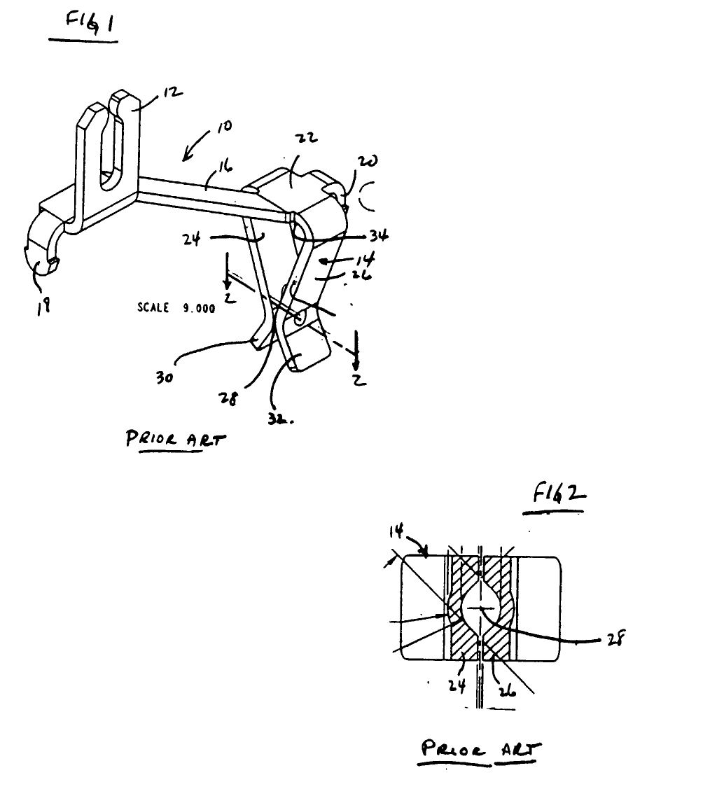

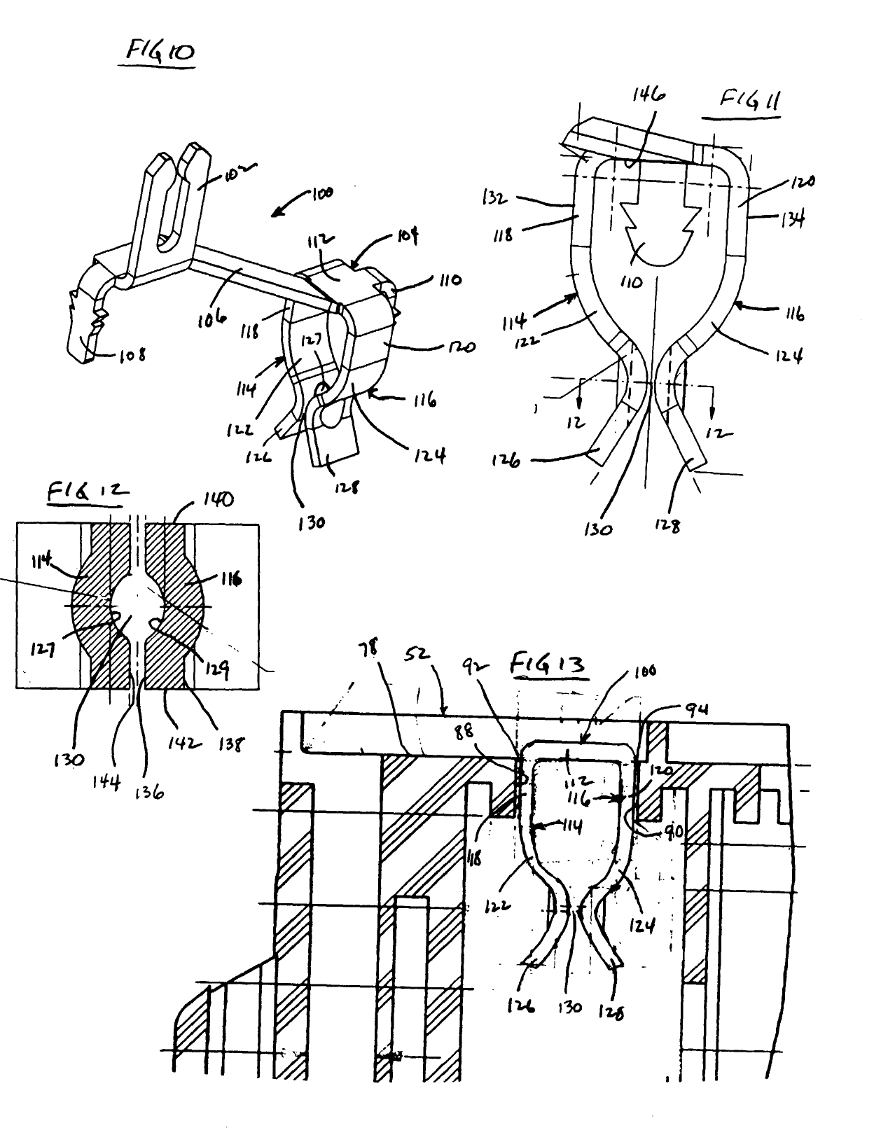

The material for the tip clip is Olin Brass C7025 phosphor bronze, a high performance alloy from both mechanical and electrical standpoints, with a thickness of 0.020 inches. The thickness is measured from the surface 136 to the surface 138, FIG. 12. The width of the tip clip arm from a surface 140 to a surface 142 has been expanded in comparison to the tip clip shown FIGS. 1 and 2 from 0.080 to 0.085 inches. The distance from the base to the contact region, however, remains at 0.227 inches. The width of the contact region (the lateral distance between the two curved walls 127, 129) has been reduced from 0.030 to 0.028 inches and the gap between the two arms adjacent the contact region from a surface 136 to a surface 144 has been expanded from 0.004 to 0.008 inches. The clip deformation increases to 0.004-0.007 inches. The distance from the bottom surface 146, FIG. 11 of the base to the end of the first portion of the arms is about 0.091 inches, and this dimension is approximately the same as the depth of the lateral walls 88, 90 of the housing extending from the housing top wall 78. The change of material, dimensions and form results in the spring constant being increased from 0.073 lb./mil to 0.1 lb./mil. The normal force at the contact region increases from 0.8 to 1.4 lbs.

The yield stress of the new material is about 85 to 110 ksi as compared to about 81 ksi for the C510 phosphor bronze used in the tip clip of FIGS. 1. It has been found that the tip clips' working stress is 62.1 ksi without the benefit of the lateral walls. The working stress of the clip will exceed its material yield stress when there is an applied force of between 1.9 and 2.47 lbs. However, under blow-off conditions the tip clip arms will be spread further and will engage the lateral walls of the housing. This abutment stiffens the tip clip. Under these conditions, the clip's working stress will exceed its material yield stress when the applied force is between 3.75 and 4.85 lbs. When tested under a 10 kA current surge, the new design avoided high current arcing and any physical damage.

The tip clip may be formed by a known stamping operation and installed on the housing in a suitable fashion known to those skilled in the art. The cartridge and its elements, including the housing, are more fully described in the U.S. Pat. No. ______ (co-pending application Ser. No. ______, entitled “Surge Protection Cartridge”).

The portion of the specification above describes in detail a preferred embodiment of the present invention. Other examples, embodiments, modifications and variations will under the literal claim language and the doctrine of equivalents come within the scope of the invention defined by the appended claims. For example, forming surge protection cartridges with greater or lesser pair counts is considered equivalent structures and will also come within the literal language of the claims. Making slight geometric changes will also come within the literal language of the claims. Still other alternatives will also be equivalent as are many new technologies. There is no desire or intention here to limit in any way the application of the doctrines of equivalents nor to limit or restrict the scope of the invention.

1. An electrical terminal for a surge protection cartridge comprising:
a metal element having a first contact portion, said first contact portion including a base, first and second spaced apart arms extending away from said base, said arms being generally parallel to one another along first portions thereof, generally converging toward but not meeting one another along second portions thereof, and being flared away from one another along third portions thereof.

2. An apparatus as claimed in claim 1 including:
a region of electrical contact on said arms at generally the junction of said second and said third portions of said arms.

3. An apparatus as claimed in claim 2 wherein:
said region of electrical contact includes generally curved walls shaped with a width between walls of about 0.028 inches.

4. An apparatus as claimed in claim 3 wherein:
adjacent the region of electrical contact said arms are spaced apart by about 0.008 inches.

5. An apparatus as claimed in claim 4 wherein:
said metal element generates between about 0.8 and about 1.4 pounds of normal force upon an inserted lead into said region of contact.

6. An apparatus as claimed in claim 5 wherein:
each of said arms is about 0.085 inches wide and about 0.020 inches thick.

7. An apparatus as claimed in claim 6 wherein:
said metal of said metal element is a high mechanical and electrical performance alloy.

8. An apparatus as claimed in claim 2 wherein:
said metal element has a spring constant of about 0.1 pounds per millimeter.

9. An apparatus as claimed in claim 8 wherein:
said region of electrical contact includes curved walls shaped with a width between walls of about 0.028 inches;
adjacent the region of electrical contact said arms are spaced apart by 0.008 inches; and
each of said arms is 0.085 inches wide and 0.020 inches thick.

10. An apparatus as claimed in claim 1 wherein:
said metal element includes a second contact portion and a bridge spanning said first and said second contact portions.

11. An electrical terminal system comprising:
a housing having an opening for receiving an electrical terminal; and
an electrical terminal mounted to said housing in said opening, said terminal having a first contact portion, said first contact portion including a base, first and second spaced apart arms extending away from said base, said arms being generally parallel to one another along first portions thereof, generally converging toward but not meeting one another along second portions thereof, and being flared away from one another along third portions thereof.

12. An apparatus as claimed in claim 11 wherein:
said opening in said housing is bordered by walls closely spaced from said electrical terminal wherein movement by said first portions of said arms is constrained.

13. An apparatus as claimed in claim 11 wherein:
exposing said electrical terminal to blow-off voltage causes said arms of said terminal to abut walls surrounding said opening in said housing.

14. An apparatus as claimed in claim 11 wherein:
said opening in said housing is bordered by walls closely spaced from said electrical terminal, said spacing between said terminal and said walls being about 0.001 inches on each side of said terminal.

15. An apparatus as claimed in claim 14 including:
a region of electrical contact on said arms at generally the junction of said second and said third portions of said arms.

16. An apparatus as claimed in claim 15 wherein:
said region of electrical contact includes generally curved walls shaped with a width between walls of 0.028 inches;
adjacent the region of electrical contact, said arms are spaced apart by about 0.008 inches; and
said metal element generates between about 0.8 and about 1.4 pounds of normal force upon an inserted lead into said region of contact.

17. An apparatus as claimed in claim 16 wherein:
each of said arms is about 0.085 inches wide and about 0.020 inches thick;
said electrical terminal is comprised of a high performance metal alloy; and
said metal alloy has a spring constant of about 0.1 pounds per millimeter.

18. An apparatus as claimed in claim 11 wherein:
said electrical terminal includes a second contact portion and a bridge spanning said first and said second contact portions.

19. An apparatus as claimed in claim 18 wherein:
said opening in said housing is bordered by walls closely spaced from said electrical terminal wherein movement by said first portions of said arms is constrained.

20. An apparatus as claimed in claim 19 wherein:
exposing said electrical terminal to blow-off force causes said arms of said terminal to abut walls surrounding said opening in said housing.
